(19) United States
(12) Patent Application Publication
(10) Pub. No.: US 2023/0158542 A1
(43) Pub. Date: May 25, 2023

(54) METHOD AND MACHINE FOR THE SURFACE TREATMENT OF A BASE CERAMIC ARTICLE

(71) Applicant: SACMI TECH S.P.A., IMOLA (IT)

(72) Inventor: Marco CANCELLARA, Imola (IT)

(21) Appl. No.: 17/997,217

(22) PCT Filed: Apr. 27, 2021
(86) PCT No.: PCT/IB2021/053458

§ 371 Date: Oct. 26, 2022

(30) Foreign Application Priority Data
Apr. 27, 2020 (IT) 102020000009067
Apr. 27, 2020 (IT) 102020000009070

(51) Int. Cl. B05C 19/04; B28B 11/00; B28B 11/04; B41M 5/00; B44C 3/02; B44C 5/04; B05C 19/06

(52) U.S. Cl. CPC B05C 19/04; B28B 11/001; B28B 11/048; B28B 11/049; B41M 5/0047; B41M 5/007; B44C 3/02; B44C 5/04; B05C 19/06

(57) ABSTRACT

A machine and method for the surface treatment of a base ceramic article having at least one surface to be treated; wherein a first printing assembly applies a first layer of adhesive material on at least part of the surface to be treated; a first depositing assembly deposits a second layer of powder material on at least part of the first layer so as to remain stuck to the first layer; and a second printing assembly applies a third layer, which comprises (in particular, consisting of) an adhesive and/or covering material, on at least part of the second layer.

### CROSS-REFERENCE TO RELATED APPLICATIONS

This patent application claims priority from Italian patent application no. 102020000009067 filed on 27 Apr. 2020 and from Italian patent application no. 102020000009070 filed on 27 Apr. 2020, the entire disclosure of which is incorporated herein by reference.

### TECHNICAL FIELD

This invention relates to a method and a machine for the surface treatment of a base ceramic article.

Specifically, this invention relates to a method and a machine for the surface treatment of slabs comprising (consisting of) ceramic material; even more specifically, of tiles comprising (consisting of) ceramic material.

### BACKGROUND OF THE INVENTION

In the field of ceramic article production, in particular ceramic slabs and tiles, it is known to subject base ceramic articles to surface treatments designed to provide the article with the desired aesthetic, mechanical, and functional properties.

The most common surface treatments are treatments to decorate the base ceramic articles. The machines known for the decoration of base ceramic articles are divided into machines for making so-called full-field decorations that affect the entire surface to be treated and machines for making patterns on part of the surface to be treated. Specifically, the machines and the processes for creating the so-called “full field” decorations involve the application of an adhesive material on basically the whole extension of the surface to be treated and, subsequently, the depositing, typically by means of depositing rollers, of a powder material, mainly consisting of ceramic powders, on the adhesive material.

On the other hand, the machines and processes for creating patterns on part of the surface to be treated involve the selective application of an adhesive material in certain defined areas of the surface to be treated in order to define the pattern and the subsequent depositing of the powder material on the entire surface to be treated, which thus remains attached to the adhesive material in the above-mentioned defined areas.

In both cases, the powder material is spread over the entire extension of the surface to be treated and in a sufficiently abundant manner to form a sufficiently thick and dense layer of powder material and to avoid the risk that areas of the base ceramic element to be decorated remain free of powder material.

However, doing so may result in not all of the applied powder material's coming into contact with the adhesive material and adhering to it. This could be a problem, as the powder material that has not adhered could move during the subsequent treatment steps to which the base ceramic article is subjected, risking soiling the machine and/or areas of the surface to be treated that should remain free of powder material, thus compromising the success of the process of decorating the base ceramic articles and risking damage to the machine for decorating the base ceramic articles.

To try to avoid this risk, known processes and machines for surface treatment, and more specifically for decoration, of base ceramic articles involve the removal of powder material that has not adhered (excess material) to the adhesive material, typically by means of suction. Obviously, this entails an additional work station inside the machine with a consequent increase in the number of machine components, the time, and cost of the treatment process and a large amount of powder material waste, which is used in excess, or in any case the need for complex and costly technical devices for a massive recirculation of the powder material that is sucked up.

Furthermore, the base ceramic articles treated with the known machines and methods described above often exhibit surface irregularities (i.e., defects), such as variations in thickness and/or density between different areas of the treated surface, caused for example by the non-uniform distribution of the ceramic powder on this surface or, in the case of selective processes (i.e., processes of applying the powder material only to certain defined areas of the surface to be treated), by the alternation of areas treated with the powder material and areas without the powder material. These surface irregularities, in addition to risking compromising the aesthetic appearance of the base ceramic article, may make the smoothing, lapping, polishing, etc. operations, to which the base ceramic article is generally subjected, more laborious and/or less effective. For example, when the treatment processes of the base ceramic articles involve the application of reagents, reinforcers, resins, or other substances to the layer of powder material, if the substrate on which these substances are applied (in the present case, the layer of powder material) is not uniform, on the one hand, the correct distribution of the above-mentioned substances may be impaired and, on the other hand, the above-mentioned surface irregularities may become even more visible.

All the drawbacks described above risk making the surface treatment processes of the base ceramic items inefficient and/or compromising the final aesthetic appearance of the ceramic products.

The purpose of this invention is to provide a method and a machine for the surface treatment of a base ceramic article, which make it possible to overcome, at least partially, the drawbacks of the prior art, while at the same time being economical and easy to implement/manufacture.

### SUMMARY

In accordance with this invention, a method and a machine for the surface treatment of a base ceramic article are provided, according to what is claimed in the appended independent claims, and preferably, in any one of the claims depending directly or indirectly on the above-mentioned independent claims.

The claims describe preferred embodiments of the present invention, forming an integral portion of this description.

### BRIEF DESCRIPTION OF THE DRAWINGS

The invention is described below with reference to the accompanying drawings which show some non-limiting embodiments of it, wherein:

FIG. 1 is a lateral and schematic view of a production plant for ceramic articles in accordance with this invention;

FIGS. 2 to 6 are schematic, lateral views of subsequent operating steps of a part of the plant in FIG. 1;

FIGS. 7 to 13 are schematic, lateral views of subsequent operating steps of a different embodiment of the part of the plant illustrated in FIGS. 2 to 6;

FIGS. 14 to 18 are lateral views of a base ceramic article subjected to different surface treatments in accordance with different embodiments of this invention; and

FIG. 19 is a schematic, perspective view of a detail of the plant in FIG. 1.

### DETAILED DESCRIPTION

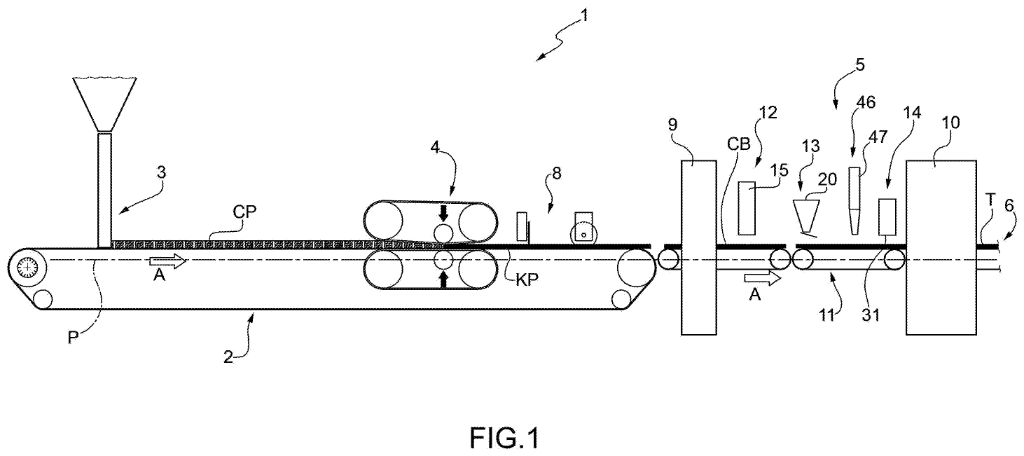

In FIG. 1, the number 1 designates, as a whole, a plant for the manufacture of a ceramic article T. In particular, the ceramic article T is a ceramic slab (more precisely, a ceramic tile).

According to some preferred but not exclusive embodiments, such as that illustrated in FIG. 1, the plant 1 comprises a conveyor assembly 2 for feeding (basically continuously) a powder material CP comprising (in particular, mainly consisting of) ceramic powder along a path P determined in a feeding direction A from an inlet station 3 towards (through) a compacting machine 4, configured to compact the powder material CP so as to obtain a compacted powder layer KP, which compacted powder layer KP is also fed along the determined path P towards (through) a machine 5 for the surface treatment of a base ceramic article CB, for example a decoration machine, to an outlet station 6. Advantageously, the base ceramic article CB comprises (at least) one portion of the compacted powder layer KP and at least one surface to be treated 7, in particular the surface to be treated 7 is the surface facing upwards (i.e. towards the surface 7 of the base ceramic article CB that is parallel to the conveyor plane but is not in contact with the conveyor assembly 2 during the feeding of the base ceramic article CB on the conveyor assembly 2 itself).

According to some non-limiting embodiments such as the one illustrated in FIG. 1, the plant 1 comprises at least one cutting assembly 8 for transversely cutting the compacted powder layer KP so as to obtain the above-mentioned base ceramic article CB. In detail, advantageously but not necessarily, the conveyor assembly 2 is specifically configured to feed the compacted powder layer KP to the cutting assembly 8 and to transport the base article CB downstream of the cutting assembly 8 itself through the machine 5 for surface treatment of the base ceramic article CB.

According to the preferred but non-limiting embodiment illustrated in FIG. 1, the compacting machine 4 and the machine 5 for the surface treatment of the base ceramic article CB are arranged along the path P between the inlet station 3 and the outlet station 6. Specifically, according to some preferred but not exclusive embodiments such as that illustrated in FIG. 1, the machine 5 is arranged downstream of the compacting machine 4. Even more specifically, the cutting assembly 8 is also arranged along the path P, in particular, downstream of the compacting machine 4 and upstream of the machine 5 for surface treatment of the base ceramic articles CB.

According to some non-limiting embodiments that are not illustrated, the plant 1 does not comprise the compacting machine 4 and the cutting assembly 8 but does comprise a conventional (known) tile-pressing machine. Typically, this pressing machine is equipped with a vertical-axis hydraulic pressing device designed to press powder ceramic material in order to directly obtain single slabs (which do not require cutting) of pressed material.

According to certain non-limiting embodiments such as the one illustrated in FIG. 1, the plant 1 also comprises a dryer 9 arranged along the path P downstream of the compacting machine 4 (more precisely, downstream of the cutting assembly 8) and upstream of the machine 5 for the surface treatment of the base ceramic articles CB. Furthermore, in accordance with other non-limiting embodiments such as the one illustrated in FIG. 1, the plant 1 comprises (also) a firing kiln 10 for sintering (the compacted powder layer KP of) the base ceramic article CB so as to obtain a ceramic product T. In particular, advantageously but not necessarily, the firing kiln 10 is arranged along the path P determined downstream of the machine 5.

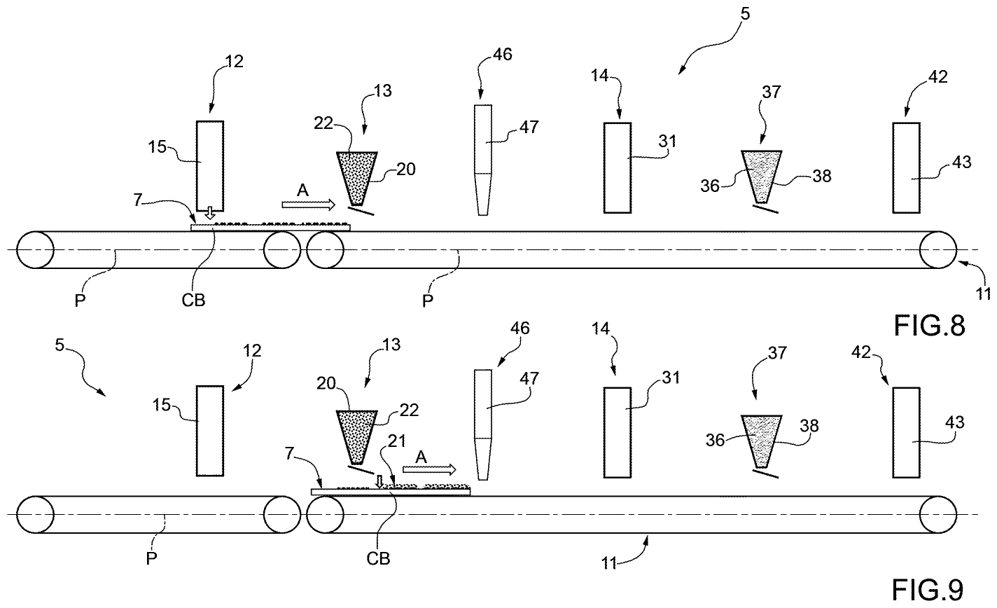

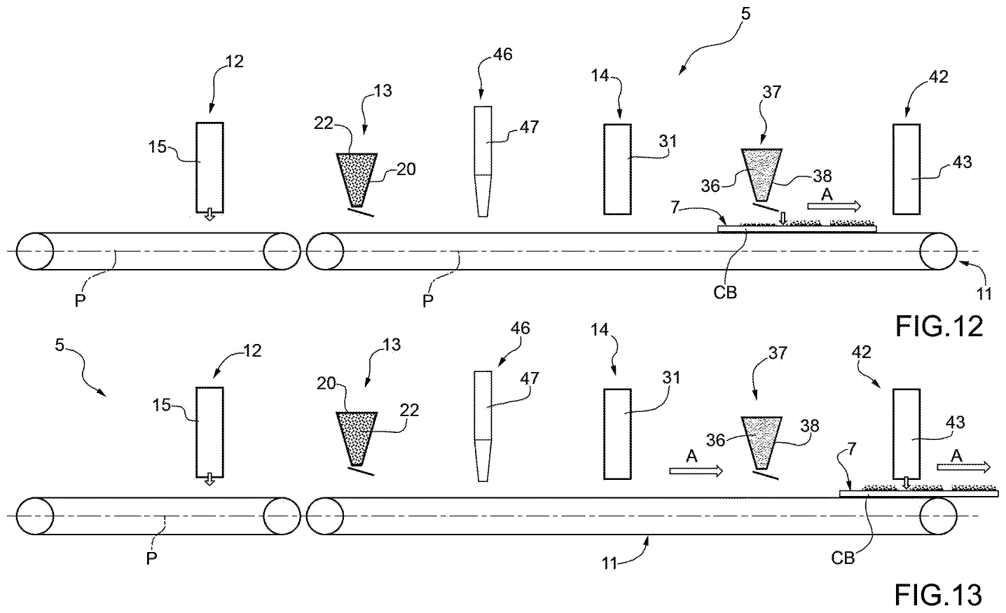

According to some preferred but not exclusive embodiments such as those illustrated in FIGS. 1 to 13, the machine 5 comprises a conveying device 11 (which is, in particular, part of the conveyor assembly 2) for feeding (preferably, with basically continuous motion) the base ceramic article CB along the path P determined in the feeding direction A through a first application station 12, a second application station 13, arranged downstream of the first application station 12, and at least one third application station 14, arranged downstream of the second application station 13.

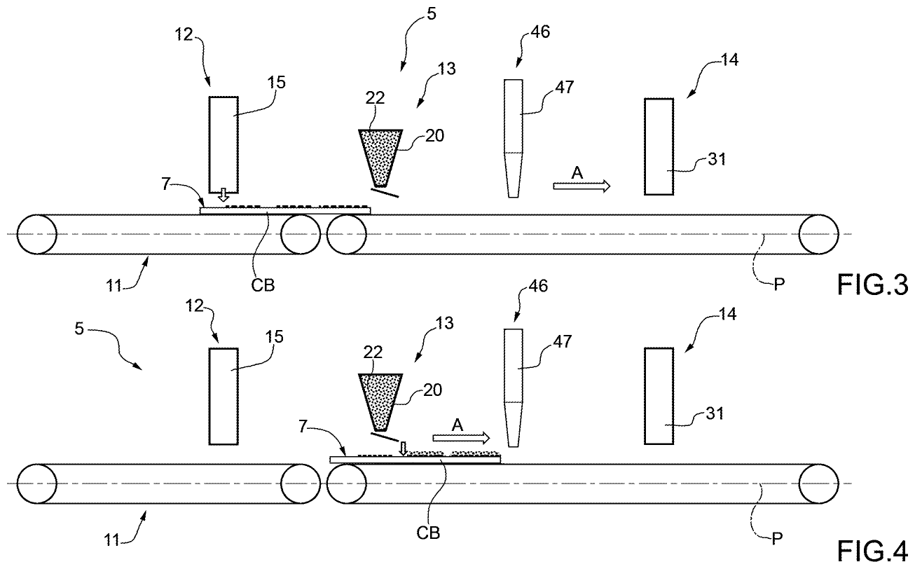

Specifically, in accordance with some preferred but not exclusive embodiments such as those illustrated in FIGS. 1 to 13, the machine 5 for the surface treatment of the base ceramic article CB comprises a printing assembly 15, which is arranged at the first application station 12 and is configured to apply a layer 16 comprising (in particular, consisting of) an adhesive material 17 on at least part of the surface to be treated 7 (see, for example, FIGS. 3, 8, and FIGS. 14 to 18).

Advantageously but not necessarily, the printing assembly 15 comprises an inkjet head (inkjet—not visible in the appended figures and known so not further described herein) configured to emit one or more jets of adhesive material 17 (selectively) onto the surface to be treated 7. In this case, advantageously but not necessarily, the adhesive material 17 is such (i.e. has a consistency and viscosity such) that it can be applied by means of an inkjet head.

In particular, according to some advantageous but not exclusive embodiments, the printing assembly 15 is configured to apply the layer 16 (in particular, selectively) to the surface to be treated 7, in at least one defined area 18 of the surface to be treated 7.

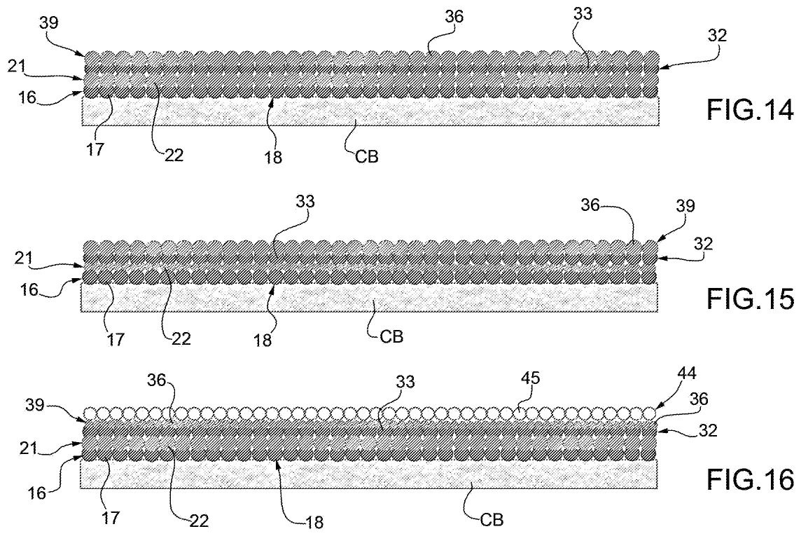

Specifically, according to some advantageous but non-limiting embodiments such as those illustrated in FIGS. 14, 15, 16, and 18, the printing assembly 15 applies the layer 16 over basically the whole extension of the surface to be treated 7. In other words, in these cases the defined area 18 has an extension that basically coincides with the extension of the surface to be treated 7.

Alternatively, in accordance with other non-limiting variants, such as those illustrated in FIGS. 3, 8, and 17, the defined area 18 is such that at least one other defined area 19 of the same surface to be treated 7 (in particular, different to the defined area 18) remains free of adhesive material 17. In other words, in this case the extension of the defined area 18 is smaller than the extension of the surface to be treated 7.

According to other non-limiting variants that are not illustrated, the printing assembly 15 is configured to apply (in particular, digitally) the adhesive material 17 so as to reproduce a defined pattern on the surface to be treated 7. In other words, the printing assembly 15 is configured to apply the adhesive material 17 so that the layer 16 defines a pattern on the surface to be treated 7.

Advantageously, the machine 5 also comprises a depositing assembly 20, which is arranged at the second application station 13 and is configured to deposit a layer 21 comprising (in particular, consisting of) a powder material 22 on the layer 16 so as to remain adhered to the adhesive material 17 of the layer 16 (see, in particular, FIGS. 4, 9, and FIGS. 14 to 18).

According to some preferred but non-limiting embodiments such as those illustrated in FIGS. 14 to 17, this layer 21 of powder material 22 is deposited over the whole extension of the layer 16. In particular, over the whole defined area 18 on which the adhesive material 17 was previously (i.e., downstream along the determined path P) deposited.

Alternatively, according to some advantageous but non-limiting embodiments such as that illustrated in FIG. 18, the layer 21 of powder material 22 is selectively deposited on the layer 16 in a part 23 of the defined area 18 so as to remain adhered to the layer 16.

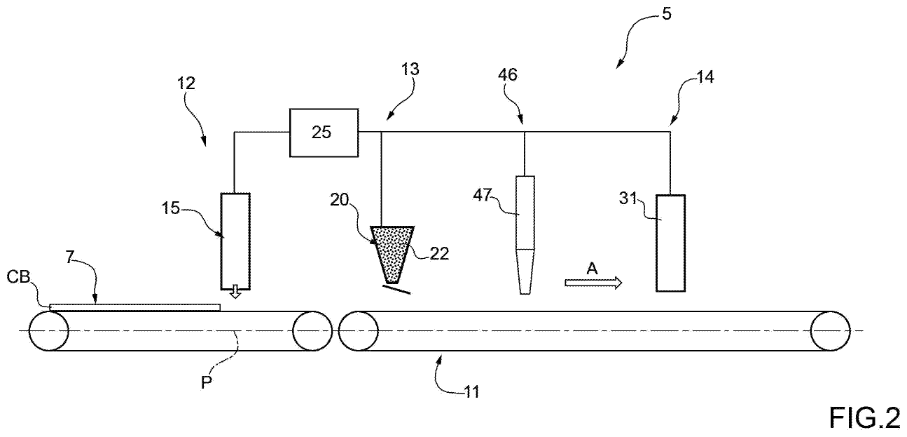

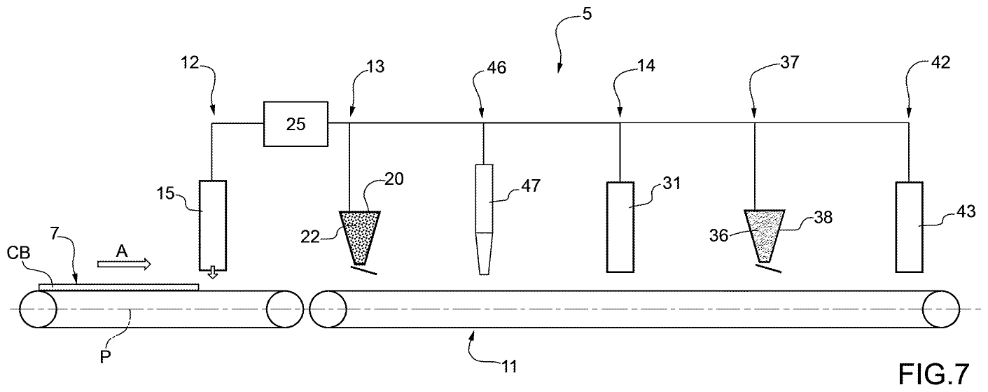

In this case, advantageously but not necessarily, the machine 5 also comprises a control unit 25 (see FIGS. 2 and 7) that is configured to control (in particular, digitally) the depositing assembly 20 so that it deposits the layer 21 of powder material 22 in the part 23 of the defined area 18 so that this layer 21 of powder material 22 remains adhered to the layer 16 and so that it does not cover at least part of the defined area 24 of the surface to be treated 7.

Advantageously, this part 23 of the defined area 18 is such that at least part of another defined area 24 of the surface to be treated 7 (in particular, of the layer 16) is not covered by the layer 21 of powder material 22.

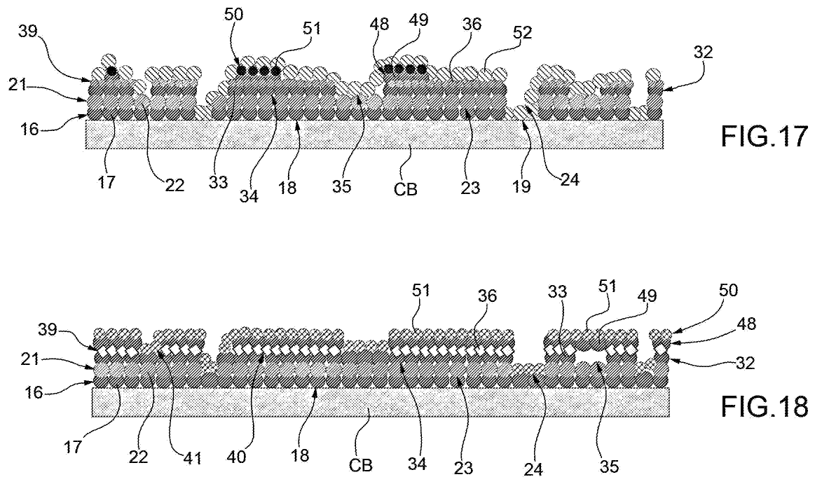

Specifically, when the extension of the defined area 18 is smaller than the extension of the surface to be treated 7 (i.e. when the layer 16 is deposited on only part of the surface to be treated 7), the defined area 24 comprises (in particular, is formed by) that part of the surface to be treated 7 on which the layer 16 has not been deposited, in other words in this case the area 24 at least partially overlaps with the area 19 (see, for example, FIG. 17). Alternatively, when the extension of the defined area 18 coincides with that of the surface to be treated 7 (i.e. when the layer 16 is deposited on basically the whole surface to be treated 7), the defined area 24 comprises (in particular, is formed by) at least part of said defined area 18, more particularly it comprises at least that part of the defined area 18 that is not covered by the layer 21 of powder material 22 (see, for example, FIG. 18).

According to some non-limiting embodiments that are not illustrated, the control unit 25 is configured to control (in particular, digitally) the depositing assembly 20 so as to reproduce a pattern defined on the layer 16. In particular, when the layer 16 is such as to reproduce a pattern on the surface to be treated 7 the two patterns (the one defined by the layer 16 and the one defined by the other layer 21) may at least partially coincide. In these cases, the control unit 25 is advantageously but not necessarily configured to also control the printing assembly 15.

In detail, advantageously but not necessarily, the distribution of the powder material 22 on the layer 16 may appear wider than the distribution of the adhesive material 17 on the surface to be treated 7 (in other words, the pattern defined by the layer 21 may appear wider than the pattern defined by the layer 16), as it may be advantageous to deposit an amount of powder material 22 slightly in excess of what is required (in order to reduce the risk that areas where there should be powder material 22 remain without the required amount). According to alternative embodiments, the distribution of the powder material 22 on the layer 16 may not appear as wide as the distribution of the adhesive material 17 on the surface to be treated 7 (in other words, the pattern defined by the layer 21 may not be as wide as the pattern defined by the layer 16). In this case, in the part of the pattern defined by the layer 16 on which the powder material 22 is not deposited, another powder material, in particular a different one from the first powder material 22, may, for example, be deposited in the same application step or in subsequent application steps.

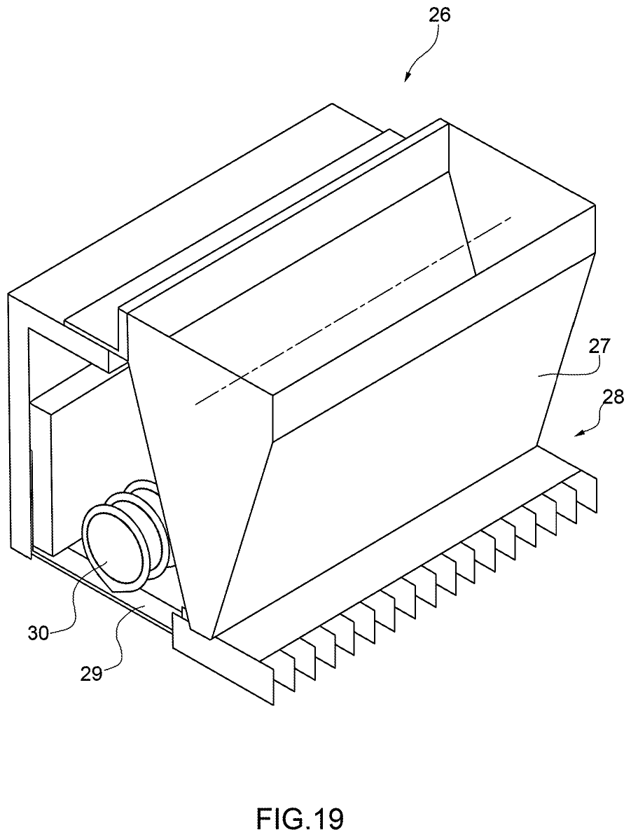

Advantageously but not necessarily, in accordance with the non-limiting embodiment illustrated in FIG. 19, the depositing assembly 20 comprises at least one depositing device 26 comprising a container 27, which is configured to contain the powder material 22 and has an output mouth 28, whose longitudinal extension is transverse (in particular, perpendicular) to the feeding direction A and a number of distribution elements 29, which are arranged in succession along the output mouth 28 and can each be operated independently of the other ones so as to allow the powder material 22 to go through an area of the output mouth 28 where it is arranged.

Even more specifically, advantageously but not necessarily, the depositing device 26 comprises a number of actuators 30, each of which is designed to move a corresponding distribution element 29 between a closed position, wherein the corresponding distribution element 29 blocks the passage of the powder material 22 through the output mouth 28 area where it is arranged, and an open position, wherein the corresponding distribution element 29 allows the passage of the powder material 22 through the output mouth 28 area in which it is arranged.

It should be noted that by using the depositing device 26, even more precise depositing (also in terms of thickness) of the powder material can be achieved.

According to certain non-limiting embodiments, the depositing assembly 20 is as described in the patent application WO2009118611 (of the same applicant) and/or in the patent IT1314623.

In addition, according to some advantageous and non-limiting embodiments that are not illustrated, the powder material 22 comprises a first type of powder material that is deposited in a region of the layer 16 (or a first part of the pattern defined by the layer 16) and a second type of powder material, different from the first type, in another region, at least partially different from the previous one, of the layer 16 (or a first part of the pattern defined by the layer 16). These regions may at least partially overlap with each other. In particular, the first and second types of powder material 22 advantageously differ from each other in their mechanical and/or physical characteristics and/or their colour.

In these cases, advantageously but not necessarily, the depositing assembly 20 comprises two depositing devices 26 that are the same and arranged side-by-side in succession along the determined path P, one intended to deposit a first type of the powder material 22 and the other intended to deposit a second type of the powder material 22 (different from the first type of powder material). This makes it possible to obtain a combination of two (or more) types of powder material in a relatively simple way, and, thus, to create particular aesthetic effects such as combinations of different colours and/or shades.

Alternatively, the depositing assembly may comprise a single depositing device 26, such as the one described above, whose container 27, in temporally successive steps, is filled with powder material 22 of the two different types.

Advantageously, the machine 5 also comprises at least one additional printing assembly 31, which is arranged at the third application station 14 and is configured to apply an additional layer 32, which comprises (in particular, consists of) an adhesive and/or covering material, on the layer 21.

Advantageously, but without imposing limits, this printing assembly 31 has a similar structure and operation to the printing assembly 15.

The fact that the adhesive material 17, the powder material 22, and this additional layer 32 are simultaneously present on the surface to be treated 7 makes it possible to reduce the risk that the powder material 22 moves on the base ceramic article CB, for example in subsequent processing steps of the base ceramic article CB itself. In other words, the presence of the additional layer 32 ensures that any powder material 22 that had not remained adhered to the underlying layer 16 is blocked by the layer 32, thereby minimising the risk of undesired movement of the powder material 22 that could soil components of the machine 5 or other parts of the plant 1, compromising its proper operation in the worst case scenario.

According to some advantageous but non-limiting embodiments that are not illustrated, the layer 32 comprises (in particular, mainly consists of) a covering material that is applied over basically the whole extension of the layer 21 to cover it. Advantageously, this covering material may be any material, for example a fixative material in order to fix the powder material 22, or a material such as to provide the surface to be treated 7 with particular aesthetic (e.g. particular gloss) and/or functional (e.g. particular roughness) properties.

According to alternative non-limiting embodiments, such as those shown in FIGS. 14 to 18, the layer 32 comprises (in particular, mainly consists of) an adhesive material 33, which is applied to the layer 21 by the printing assembly 31. This adhesive material 33 is, advantageously but not necessarily, of the same type as the other adhesive material 17.

Similarly to what has been described above in relation to the layer 16, in this case too, the printing assembly 31 may be configured to apply the layer 32 on basically the whole extension of the layer 21 so as to cover all the powder material 22, in particular on the whole part 24 of the defined area 18 (see, for example, FIGS. 14, 15, 16, and 18).

Alternatively, the printing assembly 31 may be configured to apply the layer 32 in at least one defined area 34 so that at least one other defined area 35 (in particular different to the defined area 34) remains free of adhesive material 33 (see FIGS. 17 and 18).

In this case, advantageously but not necessarily, the control unit 25 is configured to control (in particular, digitally) the printing assembly 31, so as to selectively apply the layer 32 on the layer 21, in particular on this defined area 34.

In embodiments that involve a layer 32 mainly consisting of adhesive material 33, this adhesive material 33 is intended to receive and fix an additional layer of powder material 36.

Advantageously, this enables the overlapping of several layers of powder material, which ensures greater density of the layer of powder material arranged on each base ceramic article CB, but also the possibility of creating more complex decorations, and, more generally, surface treatments, for example, by overlapping powder materials of different functional and/or mechanical and/or aesthetic characteristics.

Specifically, in accordance with these preferred but non-limiting embodiments like the one illustrated in FIGS. 7 to 13, the determined path P extends through a fourth application station 37 arranged downstream of the third application station 14, and the machine 5 comprises an additional depositing assembly 38 arranged at the application station 37 and configured to deposit a layer 39 comprising (in particular, consisting of) a powder material 36 on the layer 32 of adhesive material 33.

Advantageously, but not necessarily, this additional depositing assembly 38 has a similar structure and operation to the depositing assembly 20 described above.

The powder material 36 may be the same as the powder material 22, as illustrated in FIGS. 14 to 16, or different to the powder material 22, as illustrated in FIGS. 17 and 18.

In particular, according to some advantageous but not exclusive embodiments, the powder materials 22 and 36 differ from each other according to the average particle size. In particular, in some cases in order to obtain a more homogeneous and less porous coverage of the surface to be treated 7, it is advantageous to overlap particles of different particle sizes so that the particles of smaller size are positioned in the spaces remaining between two or more particles of larger size placed side by side. This advantageously maximises the final density of the powder layer (particularly ceramic powder layer) placed above the surface to be treated 7.

Specifically, according to some advantageous but non-limiting embodiments such as those illustrated in FIGS. 15 to 18, the powder material 22 comprises (in particular, mainly consists of) ceramic particles with sizes from approximately 75 to approximately 150 μm, more specifically from approximately 100 to approximately 125 μm, while the powder material 36 comprises (in particular, mainly consists of) ceramic particles with sizes from approximately 150 to approximately 400 μm, more particularly from approximately 200 to approximately 350 μm (see FIG. 15). Alternatively, as in the embodiments of FIGS. 16 and 17, the powder material 22 comprises (in particular, mainly consists of) ceramic particles with sizes from approximately 150 to approximately 400 μm, more particularly from approximately 200 to approximately 350 μm, while the powder material 36 comprises (in particular, mainly consists of) ceramic particles with sizes from approximately 75 to approximately 150 μm, more particularly from approximately 100 to approximately 125 μm.

Similar to the above description for the layer 21, according to some advantageous but not exclusive embodiments, the depositing assembly 38 is configured to deposit the layer 39 selectively on the layer 32 in at least one part 40 of the defined area 34.

In these cases, advantageously but not necessarily, the control unit 25 is configured to also control the depositing assembly 38 so that the powder material 36 is applied to a part 40 of the defined area 34. Specifically, advantageously but not necessarily, this defined area 40 may comprise the whole extension of the defined area 34, in other words the extension of the part 40 and the extension of the area 34 on which the layer 32 of adhesive material is deposited coincide (see, for example, FIG. 17). According to other non-limiting variants, the control unit 25 is configured to also control the depositing assembly 38 so that this depositing assembly 38 deposits the powder material 36 only on a part of the layer 32 so that a part 41 remains free of the powder material 36 (see, for example, FIG. 18). In this case, the extension of the part 40 is less than the extension of the area 34. Specifically, this other part 41 may be intended to receive another type of powder material (as illustrated in FIG. 18) or another substance, for example a covering material.

The powder material 36, similarly to what has been said above for the first powder material 22, may also comprise two different types of powder material that differ from each other in functional and/or mechanical and/or aesthetic characteristics, and which are intended to be applied to at least partially different regions of the layer 32.

According to some advantageous but not exclusive embodiments, such as those illustrated in FIGS. 7 to 13 and 16, the determined path P extends along an additional fifth application station 42, arranged downstream of the fourth application station 37, and the machine 5 comprises an additional printing assembly 43 that is configured to apply a layer 44 comprising (in particular, consisting of) a material 45, which comprises (in particular, is) a covering material, over basically the whole extension of the layer 39, so as to cover it (see, in particular, FIG. 16).

Advantageously, but not necessarily, this printing assembly 43 is similarly made and has the same operation as the printing assemblies 15 and 31.

Advantageously, the presence of the covering material 45 allows the underlying layers 21, 30 to be fixed.

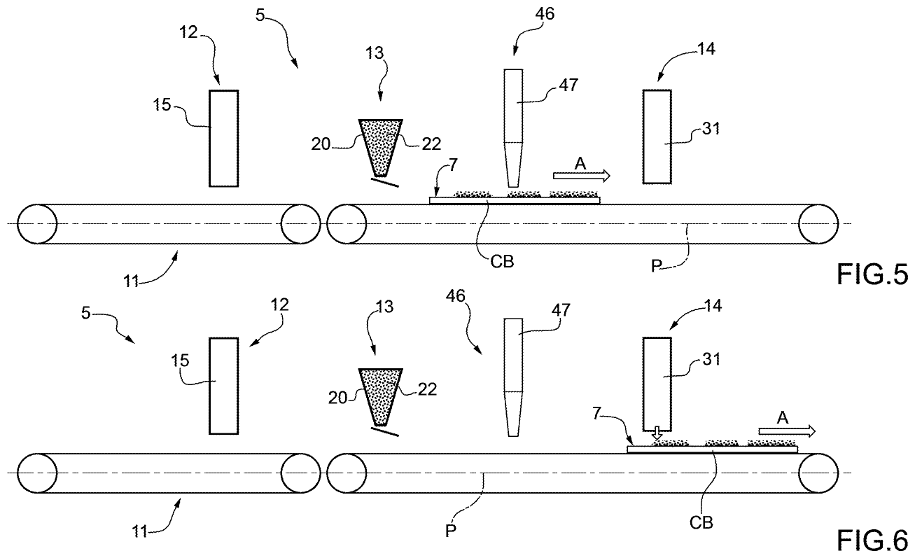

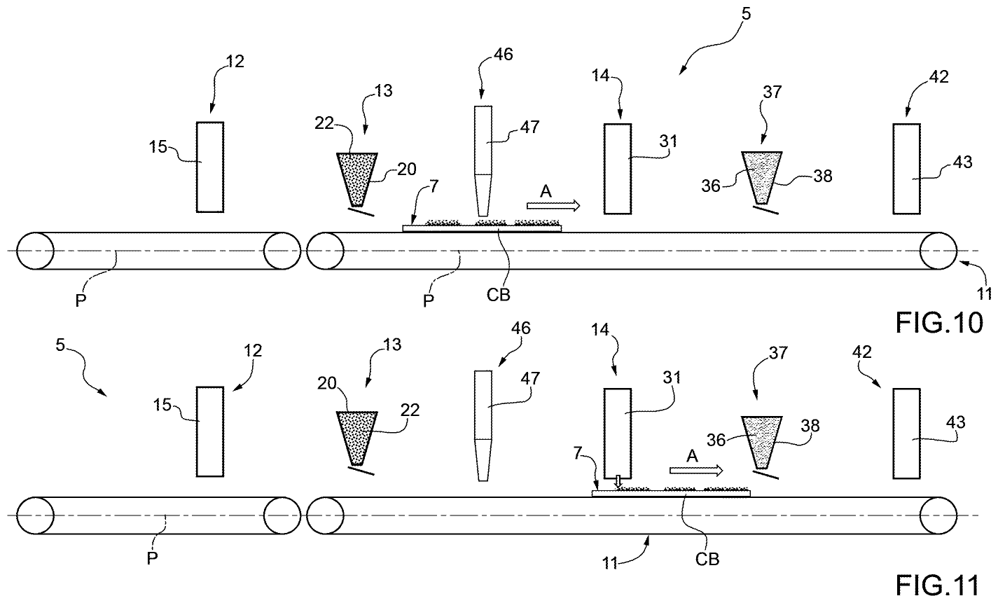

According to additional advantageous but non-limiting embodiments, such as those illustrated in FIGS. 7 to 13, the machine 5 comprises a removal station 46 arranged downstream of the second application station 13, and configured to remove, preferably by suction, the excess powder material 22, in particular the powder material 22 that has not adhered to the layer 16 (as illustrated, for example, in FIGS. 5 and 10).

Advantageously, this removal station 46 is arranged along the path P defined upstream of the third application station 14, more specifically, it is arranged between the second application station 13 and the third application station 14.

In these cases, the machine 5 comprises a (known) removal device 47 comprising a suction unit for sucking up excess powder material 22 (i.e. not bound to the surface to be treated 7 by the adhesive material 17). More specifically, this removal device 47 comprises a suction mouth designed to suck the powder material 22 that has not adhered to the layer 16 upwards.

Alternatively, the removal device 46 may be configured to remove the excess powder material 22 by blowing. However, suction is preferable as it reduces (for example compared to blowing) the risk that the powder material 22 moves to unwanted areas.

According to additional advantageous embodiments that are not illustrated, the machine 5 comprises an additional removal station arranged downstream of the application station 37, and configured to remove, preferably by suction, the excess powder material 36, in particular the powder material 36 that has not adhered to the layer 32. Specifically, this additional removal station that is not illustrated could be arranged along the path P determined between the fourth application station 37 and the fifth application station 42.

It is understood that the machine 5 may comprise any number of depositing assemblies and printing assemblies, and possibly removal devices, made according to any one of the above-described embodiments, arranged in succession so as to achieve a multi-layered treatment, for example a decoration, on the surface to be treated 7.

In accordance with an additional aspect of this invention, a method for the surface treatment of the base article CB that has at least the surface to be treated 7 is also provided.

Specifically, advantageously but not necessarily, the method comprises: a step of feeding a base ceramic article CB, during which the base ceramic article CB is fed along a path P determined in a feeding direction A through a first application station 12, a second application station 13, arranged downstream of the first application station 12, and at least a third application station 14, arranged downstream of the second application station 13; an application step, during which a printing assembly 15 arranged at the first application station 12 applies a layer 16 comprising (in particular, consisting of) a material 17, which comprises (in particular, is) an adhesive material, on at least part of the surface to be treated 7; a second application step, during which a depositing assembly 20 arranged at the second application station 13 deposits a layer 21 comprising (in particular, consisting of) a powder material 22 onto the layer 16 so as to remain adhered to the layer 16; and at least one additional application step, during which a printing assembly 31 arranged at the third application station 14 applies a layer 32 comprising (in particular, consisting of) a material, which comprises (in particular, is) an adhesive and/or covering material, onto the layer 21.

According to a preferred but not exclusive embodiment of the method, during the first application step, the printing assembly 15 applies the layer 16 in at least one defined area 18 of said surface to be treated 7; during the second application step, the depositing assembly 20 selectively deposits the layer 21 comprising (in particular, consisting of) the powder material 22 on the layer 16 in at least one part 23 of the defined area 18 so as to remain adhered to the layer 16 and so as not to cover at least a part of an additional defined area 24 of the surface to be treated 7; and during the third application step, the printing assembly 31 applies the third layer 32 on the layer 21 in another defined area 34, which is at least a portion of the part 23 of the defined area 18.

As mentioned above, with reference to the machine 5, the defined area 18 may have an extension equal to that of the surface to be treated 7 (see, in particular, FIGS. 14, 15, 16, and 18) or may have an extension smaller than that of the surface to be treated 7, so that an additional area 19 remains free of adhesive material 17.

Similarly, the part 23 of the defined area 18 may have the same extension as the defined area 18 or may have a smaller extension, in particular so as not to cover at least part of the defined area 24 of the surface to be treated 7 (or of the layer 16). Similarly, the defined area 34 may have the same extension as the part 23 of the defined area 18, or a smaller extension than the part 23 of the defined area 18.

As mentioned above with reference to the machine 5, according to some non-limiting embodiments, when adhesive material is applied during the second application step: during the feeding step, the base ceramic article CB is fed through a fourth application station 37 arranged downstream of the third application station 14; and the method comprises at least a fourth application step during which a depositing assembly 38 arranged at the fourth application station 37 deposits (preferably selectively) on at least part of the layer 32 a layer 39 comprising (in particular, consisting of) a powder material 36 so as to remain adhered to the layer 32.

In particular, advantageously but not necessarily, the depositing assembly 38 selectively deposits the layer 39 comprising the (in particular, consisting of the) powder material 36 on the layer 32 in part 40 of said defined area 34.

In this case, advantageously but not necessarily, during the feeding step, the base ceramic article CB is fed through a fifth application station 42, which is arranged downstream of the fourth application station 37; and the method also comprises a fifth application step, during which a printing assembly 43, which is arranged at the fifth application station, applies a layer 44 of a material 45 comprising (in particular, consisting of) a covering material over basically the whole extension of the layer 39 so as to cover it (see FIG. 16).

Advantageously but not necessarily, the method is implemented by the above-described machine 5. Therefore, all of the considerations set forth above regarding possible variants for operating the machine 5 also remain valid for the method for the surface treatment of the base ceramic article BC.

It is also understood that the steps of the method of this invention (carried out according to any one of the above-described embodiments) may be repeated a finite number of times, so as to achieve a multi-layered treatment, for example a decoration, on the surface to be treated 7.

According to some advantageous but not exclusive embodiments, such as the one illustrated in FIGS. 17 and 18, the method involves, for example, an additional step of applying an adhesive material, just the same as either the first or third application step described above, during which an additional layer 48 of adhesive material 49 (advantageously, the same as the adhesive material 17 and 33) is applied to at least part of the layer 39, and an additional application step during which an additional layer 50 comprising (in particular, consisting of) powder material 51 is applied to the layer 48.

According to some advantageous but non-limiting variations such as the one illustrated in FIG. 17, the method also involves a final covering step, during which a printing assembly deposits a layer of covering material 52 over basically the whole extension of the surface to be treated 7 so as to cover all the layers below.

Advantageously, by superimposing several layers of powder material, possibly of different types (e.g., of a different kind and/or particle size), various types of decoration can be obtained. For example, it is possible to obtain different colour shades in order to reproduce the appearance of natural stones more realistically, but it is also possible to achieve three-dimensional effects that were not possible until now.

a. According to some non-limiting embodiments, the adhesive material 17, 33, and 48 comprises (more precisely, consists of) mixtures containing glycols (such as DEG, PEG, Triethylene glycol bis CAS Number 94-28-0), esters (e.g., Ethylhexyl cocoate CAS Number 92044-87-6, Ethylhexyl palmitate CAS Number 29806-73-3, 2-ethylhexyl stearate CAS Number 22047-49-0, Caprylic/capric triglyceride, 2-ethylhexyl laurate CAS Number 20292-08-4), paraffins (e.g., Isoparaffin, n-paraffin), glycol ethers (such as Tripropylene glycol n-butyl ether (TPnB) CAS Number 55934-93-5, Tripropylene glycol monomethyl ether (TPM) CAS Number 25498-49-1), etc. or a combination thereof.
b. In addition or alternatively, according to some non-limiting embodiments, the adhesive material 17, 33, and 48 is selected from the group consisting of: a material (in particular, a composition) that is basically stable and does not significantly change its characteristics in contact with air and at temperatures of at least 15° C. to 60° C., a material (in particular, a composition) that is thermoplastic and hardens at room temperature.

According to some advantageous but not exclusive embodiments, the powder material 22, 36, and 51 applied to the surface to be treated 7 comprises (consists of) a ceramic material. Even more particularly, the entirety of the powder material 22, 36, and 51 applied to the surface to be treated advantageously comprises (consists of) particles with sizes from approximately 50 to approximately 500 μm, in particular from approximately 75 to approximately 350 μm.

According to alternative embodiments that are not illustrated, at least part (in particular a small part) of the powder material 22, 36, and 51 may be substituted by another type of material, for example glass material, stone material, atomized material, granules, micronized material, synthesized material, agglomerates (for example flakes and threads) that are inert (for example composed of silicon carbide), metallic powders, powders from third processes suitable for ceramic use, etc., or a combination thereof.

a. Advantageously but not necessarily, the covering material 45 and 52 comprises (in particular, consists of) a fusible substance (i.e., a substance that melts at the firing temperatures of the base ceramic article CB). In particular, this fusible substance is at least partially liquid under the application conditions (i.e., under the temperature and pressure conditions under which the fusible substance is applied).
b. More particularly, this fusible substance is in the liquid state or in suspension under the application conditions (i.e., at the application temperature and pressure). In detail, advantageously but not necessarily, the covering material 45 and 52 is selected from the group consisting of: fixative material, hardening material, reinforcing material, polishing material, iridescent material, lead enamel, alkaline enamel, alkaline earth enamel, boric enamel, zinc enamel, etc., or a combination thereof.
c. The subject of this invention has several advantages compared to the prior art. These include the following.

This invention, due to the more controlled and precise application of the powder material 22 and the presence of an additional layer 32 on top of the powder material layer 22, also allows those particles of powder material 22 that may not have adhered to the underlying layer 16 of adhesive material 17 to be fixed, minimising the risk of unwanted movement of the powder material 22. Surprisingly, this makes it possible to improve the positioning of the particles (and, therefore, the quality of the “pattern”—shape—of the part 23; the particles have less possibility of moving) and to avoid sucking the excess powder material 22, effectively making the removal step non-essential (although still advantageous) with the consequent simplification of the machine 5 and of the method for the surface treatment of the base ceramic articles CB. In addition, this entails a significant saving of powder material 22. In fact, the powder material 22 is applied in the correct amounts and basically all of it remains adhered to the base ceramic article CB. All this while, at the same time, guaranteeing improved results in terms of homogeneity of thickness and density of the treatment.

In addition, this improvement in density and thickness consistency of the layers 21, 39, and 50 of powder material 22, 36, and 52 enables the simplification of additional treatments to which the base ceramic article BC could be subjected after the application of the powder material 22, 36 and 52. Specifically, both the processes of applying additional substances on the surface to be treated and the processes of lapping and/or polishing the base ceramic article CB can be simplified. In addition, the lapping and/or polishing processes can be performed using less polishing material and/or reducing the duration of the operations, having to act on a more uniform layer.

The following aspects of the invention are also provided (alternatively or additionally).

1.—A method for the surface treatment of a base ceramic article CB having at least one surface to be treated 7; the method comprises:

a feeding step for a base ceramic article CB, during which the base ceramic article CB is fed along a given path P in a feeding direction A through a first application station 12, a second application station 13, which is arranged downstream of the first application station 12, and at least a third application station 14, which is arranged downstream of the second application station 13;

a first application step, during which a first printing assembly (15) arranged at the first application station 12 applies a first layer 16 comprising (in particular, consisting of) a first material 17, which comprises (in particular, is) an adhesive material on at least part of said surface to be treated 7;

a second application step, during which a first depositing assembly 20 arranged at the second application station 13 deposits a second layer 21 comprising (in particular, consisting of) a first powder material 22 on said first layer 16 so as to remain adhered to said first layer 16;

the first depositing assembly 20 comprising at least one container 27, which is configured to contain said powder material 22 and has an output mouth 28, whose longitudinal extension is transverse (in particular, perpendicular) to the feeding direction A; and a number of distribution elements 29, which are arranged in succession along the output mouth 28 and can each be operated independently of the other ones so as to allow the powder material 22 to go through an area of the output mouth 28 wherein it is arranged; and

a third application step, during which a second printing assembly (31) arranged at the third application station (14) applies a third layer 32 comprising (in particular, consisting of) a second material 33, which comprises (in particular, consists of) an adhesive and/or covering material, on said second layer 21.

2.—A method according to aspect 1, wherein said first powder material 22 comprises a first type of powder material in a first region of said first layer 16 and a second type of powder material, which is different from the first type, in a second region of said first layer 16, which is at least partially different from the first region.

3.—A method according to aspect 1 or 2, wherein, when the second material 33 comprises (in particular, is) an adhesive material: during said feeding step, said base ceramic article CB is fed through a fourth application station 37, which is arranged downstream of the third application station 14; and the method comprises a fourth application step, during which a second depositing assembly 38, which is arranged at said fourth application station 37 deposits, on said third layer 32 a fourth layer 39 comprising (in particular, consisting of) a second powder material 36 (in particular, different from the first powder material 22);

the second depositing assembly 38 comprising at least one additional container 27, which is configured to contain the second powder material 36 and has an additional output mouth 28, whose longitudinal extension is transverse (in particular, perpendicular) to the feeding direction A; and a number of additional distribution elements 29, which are arranged in succession along said additional output mouth 28 and can each be operated independently of the other ones so as to allow the second powder material 36 to go through an area of the additional output mouth 28 where it is arranged.

4.—A method according to aspect 3, wherein either the first powder material 22 or the second powder material 36 comprises a ceramic material comprising (in particular, consisting of) particles with dimensions ranging from approximately 75 μm to approximately 150 μm, in particular from approximately 100 μm to approximately 125 m; and the other one of the first powder material 22 or the second powder material 36 comprises a ceramic material comprising (in particular, consisting of) particles with dimensions ranging from approximately 150 μm to approximately 400 μm, in particular from approximately 200 μm to approximately 350 μm.

5.—A method according to aspect 3 or 4, wherein: during said feeding step, said base ceramic article CB is fed through a fifth application station 42, which is arranged downstream of the fourth application station 37; and the method also comprises a fifth application step, during which a third printing assembly 43, which is arranged at said fifth application station 42, applies a fifth layer 44 comprising (in particular, consisting of) a third material 45, which comprises (in particular, consists of) a covering material, basically on the whole extension of said fourth layer 39 so as to cover it.

6.—A method according to any one of aspects 1 to 5, wherein the first powder material 22, and, if necessary, the second powder material 36, comprises a ceramic material comprising (in particular, consisting of) particles with dimensions ranging from approximately 50 μm to approximately 500 μm, in particular from approximately 75 μm to approximately 350 μm.

7.—A method according to any of the aspects from 1 to 6, wherein:

said first application step, said third application step, and possibly said fifth application step are performed using a corresponding printing assembly 15, 31, 43 applying said first material 17, said second material 33, and possibly said third material 45, 49, respectively, by the emission of at least one jet of said first material 17, said second material 33, and possibly said third material 45, 49;

a. in particular, each printing assembly 15, 31, 43 comprises an inkjet head for emitting one or more jets of adhesive material and/or covering material; in particular, each printing assembly 15, 31, 43 applies said first layer 16, said third layer 32 and, when required, said fifth layer 44, 48, digitally so as to reproduce a defined pattern.

8.—A method according to any one of aspects 1 to 7, wherein said covering material comprises (in particular, consists of) a fusible substance at least partially liquid under the application conditions, in particular in a liquid state or in a suspension under the application conditions; even more particularly, said covering material is selected from the group consisting of: fixative material, hardening material, reinforcing material, polishing material, iridescent material, lead enamel, alkaline enamel, alkaline earth enamel, boric enamel, zinc enamel, or a combination thereof.

9.—A method according to any one of aspects 1 to 8, wherein at least during the first application step, said first printing assembly 15 applies said first layer 16 on at least part of said surface to be treated 7 so as to reproduce a defined pattern on the surface to be treated 7; during said second application step, said first depositing assembly (20) deposits said second layer 21 (in particular, selectively) on said first layer 16 so as to reproduce an additional defined pattern on said first layer 16; in particular, the pattern and the additional pattern coincide.

10.—A machine 5 for the surface treatment of a base ceramic article CB having at least one surface to be treated 7; the machine 5 comprises:

a conveying device 11 to feed the base ceramic article CB along a given path P in a feeding direction A through a first application station 12, a second application station 13, which is arranged downstream of the first application station 12, and at least a third application station 14, which is arranged downstream of the second application station 13;

a first printing assembly 15, which is arranged at the first application station 12 and is configured to apply a first layer 16 comprising (in particular, consisting of) a first material 17, which comprises (in particular, is) an adhesive material, on at least part of said surface to be treated 7;

a depositing assembly 20, which is arranged at the second application station 13 and comprises at least one container 27, which is configured to contain a first powder material 22 and has an output mouth 28, whose longitudinal extension is transverse (in particular, perpendicular) to the feeding direction A and a number of distribution elements 29, which are arranged in succession along said output mouth 28 and can each be operated independently of the other ones so as to allow said first powder material 22 to go through an area of the output mouth 28, wherein it is arranged, so as to deposit a second layer 21 comprising (in particular, consisting of) said first powder layer 22 on said first layer (16) so as to remain adhered to said first layer 16;

a second printing assembly 31, which is arranged at said third application station 14 and is configured to apply a third layer 32 comprising (in particular, consisting of) a second material 33, which comprises (in particular, consists of) an adhesive material and/or a covering material, on said second layer 21.

11.—A machine 5 according to aspect 10, wherein:

when said second material 33 is adhesive, said determined path P extends through at least a fourth application station 37 arranged downstream of said third application station 14; and said machine 5 comprises a second depositing assembly 38, which is arranged at said fourth application station 37 and comprises an additional container 27, which is configured to contain a second powder material 36 and has an additional output mouth 28, whose longitudinal extension is transverse (in particular, perpendicular) to the feeding direction A and a plurality of additional distribution elements 29, which are arranged in succession along said additional output mouth 28 and can each be operated independently of the other ones so as to allow the powder material 36 to go through an additional area of said additional output mouth 28, wherein it is arranged, so as to deposit a fourth layer 39 comprising (in particular, consisting of) said second powder material 36 on said third layer 32 so that said powder material remains adhered to said third layer 32.

12.—A machine according to aspect 11, wherein said given path (P) extends through a fifth application station 42, which is arranged downstream of said fourth application station 37, and the machine 5 comprises a third printing assembly 43, which is arranged at said fifth application station 42 and is configured to apply a fifth layer 44 comprising (in particular, consisting of) a third material 45, which comprises (in particular, is) a covering material, basically on the whole extension of said fourth layer 39 so as to cover it.

13.—A machine (5) according to any one of aspects 10 to 12, wherein the (possibly each) depositing assembly 20, 38 comprises a number of actuators 30, each of which is designed to move a corresponding distribution element 29 between a closed position, wherein the corresponding distribution element 29 blocks the passage of the powder material 22, 36 through the output mouth 28 area in which it is arranged, and an open position, wherein the corresponding distribution element 29 allows the passage of the powder material 22, 36 through the output mouth 28 area in which it is arranged.

14.—A machine (5) according to any one of aspects 10 to 13, wherein each printing assembly 15, 31, 43 comprises at least one inkjet head, which is configured to emit one or more jets of adhesive material and/or covering material.

15.—A machine (5) according to any one of aspects 10 to 14, and comprising a control unit 25, which is configured to control (in particular, digitally) at least said first printing assembly 15 and said first depositing assembly (20) so that said first printing assembly 15 itself applies said first layer 16 in order to reproduce a defined pattern on said surface to be treated 7; the control unit 25 is configured to control (in particular, digitally) said first depositing assembly 20 so that the first depositing assembly 20 itself deposits the second layer 21 (in particular, selectively) on said first layer 16 so as to reproduce another pattern defined on the surface on said first layer 16; in particular, the pattern and the additional pattern coincide.

1-16. (canceled)

17. A method for the surface treatment of a base ceramic article (CB) having at least one surface to be treated; the method comprises:
a feeding step for a base ceramic article (CB), during which the base ceramic article (CB) is fed along a given path (P) in a feeding direction (A) through a first application station, a second application station, which is arranged downstream of the first application station, and at least a third application station, which is arranged downstream of the second application station;
a first application step, during which a first printing assembly arranged at the first application station applies a first layer comprising (in particular, consisting of) a first material, which comprises (in particular, is) an adhesive material, in the area of at least a first defined zone of said surface to be treated;
a second application step, during which a first depositing assembly arranged at the second application station selectively deposits a second layer comprising (in particular, consisting of) a first powder material on said first layer in the area of at least a first part of said first defined zone so that it sticks to said first layer and so as not to cover at least part of a second defined zone of said surface to be treated; and
a third application step, during which a second printing assembly arranged at the third application station selectively applies a third layer comprising (in particular, consisting of) a second material, which comprises (in particular, consists of) an adhesive and/or covering material, on said second layer at a third defined zone, which is at least a portion of said first part of said first defined zone.

18. A method according to claim 17, wherein, during said first application step, said first printing assembly applies said first material at said first defined zone of said surface to be treated in such a way that at least a fourth defined zone of said surface to be treated, which is different from said first defined zone, remains without said first material.

19. The method according to claim 17, wherein the extension of said first part of said first defined zone and the extension of said first defined zone coincide.

20. The method according to claim 17, wherein said second defined zone comprises at least part of said first defined zone.

21. The method according to claim 17, wherein said first powder material comprises a first type of powder material at of a first region of the first layer and a second type of powder material, which is different from the first type, at a second region of said first layer, which is at least partially different from the first region.

22. The method according to claim 17, wherein, when the second material comprises (in particular, is) an adhesive material:
during said feeding step, said base ceramic article (CB) is fed through a fourth application station, which is arranged downstream of the third application station; and
the method comprises at least a fourth application step, during which a second depositing assembly, which is arranged at said fourth application station selectively deposits, on said third layer in the area of at least a first part of said third defined zone, a fourth layer comprising (in particular, consisting of) a second powder material (in particular, different from the first powder material) so that it sticks to said third layer.

23. The method according to claim 22, wherein, during said fourth application step, said second depositing assembly deposits said second powder material in such a way that at least a second part of said third defined zone, which is different from said first part of said third defined zone, remains without said second powder material.

24. The method according to claim 22, wherein:
one of the first powder material or the second powder material comprises a ceramic material comprising (in particular, consisting of) particles with dimensions ranging from approximately 75 μm to approximately 150 μm, in particular from approximately 100 μm to approximately 125 m; and
the other one of the first powder material and the second powder material comprises a ceramic material comprising (in particular, consisting of) particles with dimensions ranging from approximately 150 μm to approximately 400 μm, in particular from approximately 200 μm to approximately 350 μm.

25. The method according to claim 22, wherein:
during said feeding step, said base ceramic article (CB) is fed through a fifth application station, which is arranged downstream of the fourth application station; and
the method also comprises a fifth application step, during which a third printing assembly, which is arranged at said fifth application station, applies a fifth layer comprising (in particular, consisting of) a third material, which comprises (in particular, consists of) a covering material, substantially on the entire extension of said fourth layer so as to cover it.

26. The method according to claim 17, wherein the first powder material, and, if necessary, the second powder material, comprises a ceramic material comprising (in particular, consisting of) particles with dimensions ranging from approximately 50 μm to approximately 500 μm, in particular from approximately 75 μm to approximately 350 μm.

27. The method according to claim 17, further comprising:
a removal step, which takes place at a removal station arranged downstream of the second application station and during which the excess first powder material (in particular, the one that does not stick to the first layer) is removed (in particular, through suction);
in particular, the removal station is arranged upstream of the third application station; and
in particular, the method comprises a further removal step, which takes place at a further removal station arranged downstream of the fourth application station and during which the excess second powder material (in particular, the one that does not stick to said third layer) is removed through suction;
even more in particular, said further removal station is arranged upstream of the fifth application station.

28. The method according to claim 17, wherein:
said first application step, said third application step and, if necessary, said fifth application step are carried out by means of a respective printing assembly, which applies said adhesive material and/or said covering material through the emission of at least one jet of adhesive material or of covering material;
in particular, each printing assembly comprises an inkjet head to emit one or more jets of adhesive material and/or of covering material;
in particular, each printing assembly digitally applies said first layer, said third layer and, when present, said fifth layer so as to reproduce a defined pattern.

29. A machine for the surface treatment of a base ceramic article (CB) having at least one surface to be treated; the machine comprises:
a conveying device to feed the base ceramic article (CB) along a given path (P) in a feeding direction (A) through a first application station, a second application station, which is arranged downstream of the first application station, and at least a third application station, which is arranged downstream of the second application station;
a first printing assembly, which is arranged at the first application station and is configured to apply a first layer comprising (in particular, consisting of) a first material, which comprises (in particular, is) an adhesive material, on at least a first defined zone of said surface to be treated;
a depositing assembly, which is arranged at the second application station and is configured to selectively deposit a second layer comprising (in particular, consisting of) a first powder material on said first layer;
a control unit, which is configured to control (in particular, in a digital manner) said first depositing assembly in such a way that said first depositing assembly deposits said second layer in the area of at least a first part of said first defined zone so that it sticks to said first layer and so as not to cover at least part of a second defined zone of said surface to be treated; and
a second printing assembly, which is arranged at said third application station and is configured to selectively apply a third layer comprising (in particular, consisting of) a second material, which comprises (in particular, consists of) an adhesive and/or covering material, on said second layer at a third defined zone, which comprises (in particular, is) at least a portion of said first part of the first defined zone.

30. The machine according to claim 29, wherein:
when said second material is adhesive, said given path (P) extends through at least a fourth application station, which is arranged downstream of the third application station;
said machine comprises a second depositing assembly, which is arranged at said fourth application station and is configured to selectively deposit a fourth layer comprising (in particular, consisting of) a second powder material, on said third layer; and
said control unit is configured to control (in particular, in a digital manner) said second depositing assembly in such a way that said second depositing assembly deposits said second powder material (in particular, different from the first powder material) in the area of at least a first part of said third defined zone so that it sticks to said third layer.

31. The machine according to claim 30, wherein:
said given path (P) extends through a fifth application station, which is arranged downstream of said fourth application station, and
the machine comprises a third printing assembly, which is arranged at said fifth application station and is configured to apply a fifth layer comprising (in particular, consisting of) a third material, which comprises (in particular, consists of) a covering material, substantially on the entire extension of said fourth layer so as to cover it.

32. The machine according to claim 29, wherein each depositing assembly comprises:
a relative container, which is configured to contain the powder material and has an output mouth, whose longitudinal extension is transverse (in particular, perpendicular) to the feeding direction (A); and
a relative plurality of distribution elements, which are arranged in succession along the output mouth and can each be operated independently of the other ones so as to allow the powder material to go through an area of said further output mouth where it is arranged.
